(19) United States
(12) Patent Application Publication
(10) Pub. No.: US 2006/0051287 A1
(43) Pub. Date: Mar. 9, 2006

(54) Processes for producing Bi12MO20 precursors, Bi12MO20 particles, and photo-conductor layers

(75) Inventor: Ryouzou Kaito, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/217,425

(22) Filed: Sep. 2, 2005

(30) Foreign Application Priority Data
Sep. 3, 2004 (JP) 257094/2004
Sep. 3, 2004 (JP) 257095/2004
Sep. 3, 2004 (JP) 257096/2004

(51) Int. Cl. C01G 23/00

(52) U.S. Cl. 423/598

(57) ABSTRACT

A mixed solution of a bismuth salt and a metal alkoxide is mixed together with an aqueous alkali solution, and a Bi₁₂MO₂₀ precursor, in which M represents at least one kind of element selected from the group consisting of Ge, Si, and Ti, is thereby obtained. The Bi₁₂MO₂₀ precursor is subjected to molding processing, the thus molded Bi₁₂MO₂₀ precursor is subjected to firing processing, and a photo-conductor layer is thereby produced. Alternatively, the Bi₁₂MO₂₀ precursor is subjected to heating processing in an alkaline liquid phase or to firing processing, and Bi₁₂MO₂₀ particles are thereby obtained. A photo-conductor layer is produced by use of the thus obtained Bi₁₂MO₂₀ particles.

### BACKGROUND OF THE INVENTION

1. Field of the Invention

This invention relates to a process for producing a Bi₁₂MO₂₀ precursor. This invention also relates to a process for producing Bi₁₂MO₂₀ particles, which are suitable for use in a photo-conductor layer for constituting a radiation imaging panel. This invention further relates to a process for producing a photo-conductor layer for constituting a radiation imaging panel.

2. Description of the Related Art

There have heretofore been proposed X-ray imaging panels designed for use in a medical X-ray image recording operation, such that a radiation dose delivered to an object during the medical X-ray image recording operation may be kept small, and such that the image quality of an image and its capability of serving as an effective tool in, particularly, the efficient and accurate diagnosis of an illness may be enhanced. With the proposed X-ray imaging panels, a photo-conductor layer sensitive to X-rays is employed as a photosensitive material. The photo-conductor layer is exposed to X-rays carrying X-ray image information, and an electrostatic latent image is thereby formed on the photo-conductor layer. Thereafter, the electrostatic latent image, which has been formed on the photo-conductor layer, is read out by use of light or a plurality of electrodes. The techniques utilizing the X-ray imaging panels have advantages over the known photo-fluorography utilizing TV image pickup tubes in that an image is capable of being obtained with a high resolution.

Specifically, when X-rays are irradiated to a charge forming layer located in the X-ray imaging panel, electric charges corresponding to X-ray energy are formed in the charge forming layer. The thus formed electric charges are read out as an electric signal. The photo-conductor layer described above acts as the charge forming layer. As the material for the photo-conductor layer, amorphous selenium (a-Se) has heretofore been used. However, ordinarily, amorphous selenium has the problems in that it is necessary for the layer thickness of the photo-conductor layer to be set to be large (e.g., at least 500 μm) because of a low radiation absorptivity.

However, if the layer thickness of the photo-conductor layer is set to be large, the problems will occur in that the speed, with which the electrostatic latent image is read out, becomes low. Also, the problems will occur in that, since a high voltage is applied across the photo-conductor layer at least during a period from the beginning of the read-out operation after the formation of the electrostatic latent image to the end of the read-out operation, a dark current becomes large, electric charges occurring due to the dark current are added to the latent image charges, and the contrast in a low dose region becomes low. Further, since the high voltage is applied across the photo-conductor layer, device deterioration is apt to occur, durability becomes low, and electric noise is apt to occur. Furthermore, ordinarily, the photo-conductor layer is formed with a vacuum evaporation technique. Therefore, considerable time is required to grow the photo-conductor layer up to the large layer thickness described above with the vacuum evaporation technique, and management of the growth of the photo-conductor layer is not easy to perform. As a result, the production cost of the photo-conductor layer is not capable of being kept low, and the cost of the X-ray imaging panel is not capable of being kept low.

Because of the problems described above, it has been studied to utilize materials for the photo-conductor layer other than amorphous selenium. By way of example, as a substance for constituting the photo-conductor layer, there has been proposed a bismuth oxide type of composite oxide. The proposed bismuth oxide type of the composite oxide may be represented by the formula BiₓMO_{y}, in which M represents at least one kind of element selected from the group consisting of Ge, Si, and Ti, x represents a number satisfying the condition 10≦x≦14, and y represents the stoichiometric oxygen atom number in accordance with M and x. The proposed bismuth oxide type of the composite oxide is described in, for example, each of Japanese Unexamined Patent Publication Nos. 11(1999)-237478 and 2000-249769. With the proposed bismuth oxide type of the composite oxide, it is expected that the efficiency, with which the X-rays are converted into the electric charges, will be capable of being enhanced.

Also, a technique for synthesizing Bi₁₂MO₂₀ is described in, for example, “Solution synthesis and characterization of sillenite phases, Bi₂₄M₂O₄₀ (M=Si, Ge, V, As, P)” by H. S. Horowitz, et al., Solid State Ionics, 32/33, pp. 678-690, 1989. The technique for synthesizing Bi₁₂MO₂₀ described in the aforesaid literature comprises the steps of dissolving Bi(NO₃)₃ and an element source, which is selected from the group consisting of Na₂O.xSiO₂ acting as an Si source, GeO₂ acting as a Ge source, and Ti(OC₃H₇)₄ acting as a Ti source, in an acid, causing precipitation to occur by the addition of an alkali metal hydroxide, adjusting a pH value, and setting the temperature at an appropriate temperature, whereby Bi₁₂MO₂₀ is synthesized.

Further, a technique for synthesizing Bi₁₂TiO₂₀ particles is described in, for example, “Hydrothermal synthesis and characterization of Bi₄Ti₃O₁₂ powders from different precursors” by D. Chen and X. Jiao, Materials Research Bulletin, 36(2001), pp. 355-363. The technique for synthesizing Bi₁₂TiO₂₀ particles described in the aforesaid literature comprises the steps of preparing a precursor by the addition of an aqueous NH₃ solution to a mixed solution of Bi (NO₃)₃ and TiCl₄, and performing hydrothermal heating with a KOH solvent, whereby the Bi₁₂TiO₂₀ particles are synthesized.

Ordinarily, Bi₁₂MO₂₀ having been synthesized with a solid phase technique, in which Bi₂O₃ and MO₃ are subjected to firing at a temperature of 800° C., has the problems in that the particle diameter is on the order of as large as a micron size, and in that the photo-conductor layer formed from the thus synthesized Bi₁₂MO₂₀ has only a small effect of collecting the formed electric charges due to a low packing density. In each of Japanese Unexamined Patent Publication Nos. 11(1999)-237478 and 2000-249769, as a technique for forming the photo-conductor layer, a technique is described, wherein a sol or a gel having been obtained from hydrolysis of a bismuth alkoxide and a metal alkoxide is subjected to sintering processing, and wherein the resulting sintering product is subjected to dispersion and coating.

However, with the technique for forming the photo-conductor layer described in each of Japanese Unexamined Patent Publication Nos. 11(1999)-237478 and 2000-249769, the problems are encountered in that, since the alkoxides are utilized as both the bismuth source and the metal source, the cost of the raw materials is not capable of being kept low. Also, the problems are often encountered in that, if the rate of hydrolysis of the bismuth alkoxide and the rate of hydrolysis of the metal alkoxide are not matched with each other, only the oxide of bismuth or only the oxide of the metal will be formed. Therefore, a complicated control operation is required for the rate of hydrolysis.

Also, with the technique for synthesizing Bi₁₂MO₂₀ described in “Solution synthesis and characterization of sillenite phases, Bi₂₄M₂O₄₀ (M=Si, Ge, V, As, P)” by H. S. Horowitz, et al., Solid State Ionics, 32/33, pp. 678-690, 1989, actually, it is not always possible to synthesize Bi₁₂TiO₂₀. Further, as described in “Materials Research Bulletin,” 36, pp. 355-363, 2001, it is not always possible to obtain Bi₁₂MO₂₀, which has a high purity, with the combination of a bismuth salt and a metal salt.

### SUMMARY OF THE INVENTION

The primary object of the present invention is to provide a process for producing a Bi₁₂MO₂₀ precursor.

Another object of the present invention is to provide a process for producing Bi₁₂MO₂₀ particles, which are suitable for use in a photo-conductor layer for constituting a radiation imaging panel.

A further object of the present invention is to provide a process for producing a photo-conductor layer for constituting a radiation imaging panel.

The present invention provides a process for producing a Bi₁₂MO₂₀ precursor, comprising the steps of:
i) preparing a mixed solution of a bismuth salt and a metal alkoxide, and
ii) mixing the mixed solution of the bismuth salt and the metal alkoxide together with an aqueous alkali solution,
whereby a Bi₁₂MO₂₀ precursor, in which M represents at least one kind of element selected from the group consisting of Ge, Si, and Ti, is obtained.

The process for producing a Bi₁₂MO₂₀ precursor in accordance with the present invention should preferably be modified such that the bismuth salt is selected from the group consisting of bismuth nitrate and bismuth acetate.

The present invention also provides a first process for producing a photo-conductor layer for constituting a radiation imaging panel, which photo-conductor layer is capable of recording radiation image information as an electrostatic latent image, the process comprising the steps of:
i) preparing a mixed solution of a bismuth salt and a metal alkoxide,
ii) mixing the mixed solution of the bismuth salt and the metal alkoxide together with an aqueous alkali solution, a Bi₁₂MO₂₀ precursor, in which M represents at least one kind of element selected from the group consisting of Ge, Si, and Ti, being thereby obtained,
iii) subjecting the thus obtained Bi₁₂MO₂₀ precursor to molding processing, and
iv) subjecting the thus molded Bi₁₂MO₂₀ precursor to firing processing,
whereby the photo-conductor layer is produced.

The first process for producing a photo-conductor layer for constituting a radiation imaging panel in accordance with the present invention should preferably be modified such that the molding processing of the Bi₁₂MO₂₀ precursor is performed with a cold isostatic pressing technique (i.e., a CIP technique) In such cases, the first process for producing a photo-conductor layer for constituting a radiation imaging panel in accordance with the present invention should more preferably be modified such that the molding processing is performed at a pressure falling within the range of 100 MPa to 700 MPa.

The present invention further provides a first process for producing Bi₁₂MO₂₀ particles, comprising the steps of:
i) preparing a mixed solution of a bismuth salt and a metal alkoxide,
ii) mixing the mixed solution of the bismuth salt and the metal alkoxide together with an aqueous alkali solution, a Bi₁₂MO₂₀ precursor, in which M represents at least one kind of element selected from the group consisting of Ge, Si, and Ti, being thereby obtained, and
iii) subjecting the thus obtained Bi₁₂MO₂₀ precursor to heating processing in an alkaline liquid phase,
whereby the Bi₁₂MO₂₀ particles are obtained.

The term “heating processing in an alkaline liquid phase” as used herein means the processing, in which the Bi₁₂MO₂₀ precursor having been obtained from the mixing of the mixed solution of the bismuth salt and the metal alkoxide together with the aqueous alkali solution is subjected to liquid-phase heating in the alkaline state. In such cases, for example, an aqueous alkali solution may further be added to the reaction mixture containing the Bi₁₂MO₂₀ precursor. Alternatively, the solvents may be removed from the reaction mixture containing the Bi₁₂MO₂₀ precursor, and an aqueous alkali solution may then be added to the Bi₁₂MO₂₀ precursor.

The first process for producing Bi₁₂MO₂₀ particles in accordance with the present invention should preferably be modified such that the heating processing in the alkaline liquid phase is hydrothermal processing.

Also, the first process for producing Bi₁₂MO₂₀ particles in accordance with the present invention should preferably be modified such that the heating processing in the alkaline liquid phase is performed at a temperature falling within the range of 50° C. to 250° C. The temperature, at which the heating processing in the alkaline liquid phase is performed, may vary in accordance with the selection of the kind of the bismuth salt, the selection of the kind of the metal alkoxide, the selection of the kind of the aqueous alkali solution, and the combination of the bismuth salt, the metal alkoxide, and the aqueous alkali solution.

Further, the first process for producing Bi₁₂MO₂₀ particles in accordance with the present invention should preferably be modified such that the bismuth salt is selected from the group consisting of bismuth nitrate and bismuth acetate.

The present invention still further provides a second process for producing a photo-conductor layer for constituting a radiation imaging panel, which photo-conductor layer is capable of recording radiation image information as an electrostatic latent image, the process comprising the steps of:
i) preparing a mixed solution of a bismuth salt and a metal alkoxide,
ii) mixing the mixed solution of the bismuth salt and the metal alkoxide together with an aqueous alkali solution, a Bi₁₂MO₂₀ precursor, in which M represents at least one kind of element selected from the group consisting of Ge, Si, and Ti, being thereby obtained,
iii) subjecting the thus obtained Bi₁₂MO₂₀ precursor to heating processing in an alkaline liquid phase, Bi₁₂MO₂₀ particles being thereby obtained, and
iv) producing the photo-conductor layer by use of the thus obtained Bi₁₂MO₂₀ particles.

The present invention also provides a second process for producing Bi₁₂MO₂₀ particles, comprising the steps of:
i) preparing a mixed solution of a bismuth salt and a metal alkoxide,
ii) mixing the mixed solution of the bismuth salt and the metal alkoxide together with an aqueous alkali solution, a Bi₁₂MO₂₀ precursor, in which M represents at least one kind of element selected from the group consisting of Ge, Si, and Ti, being thereby obtained, and
iii) subjecting the thus obtained Bi₁₂MO₂₀ precursor to firing processing,
whereby the Bi₁₂MO₂₀ particles are obtained.

The second process for producing Bi₁₂MO₂₀ particles in accordance with the present invention should preferably be modified such that the bismuth salt is selected from the group consisting of bismuth nitrate and bismuth acetate.

The present invention further provides a third process for producing a photo-conductor layer for constituting a radiation imaging panel, which photo-conductor layer is capable of recording radiation image information as an electrostatic latent image, the process comprising the steps of:
i) preparing a mixed solution of a bismuth salt and a metal alkoxide,
ii) mixing the mixed solution of the bismuth salt and the metal alkoxide together with an aqueous alkali solution, a Bi₁₂MO₂₀ precursor, in which M represents at least one kind of element selected from the group consisting of Ge, Si, and Ti, being thereby obtained,
iii) subjecting the thus obtained Bi₁₂MO₂₀ precursor to firing processing, Bi₁₂MO₂₀ particles being thereby obtained, and
iv) producing the photo-conductor layer by use of the thus obtained Bi₁₂MO₂₀ particles.

With the process for producing a Bi₁₂MO₂₀ precursor in accordance with the present invention, the mixed solution of the bismuth salt and the metal alkoxide is mixed together with the aqueous alkali solution, and the Bi₁₂MO₂₀ precursor is thereby obtained. Therefore, the purity of the metal is capable of being kept higher than the metal purity obtained in cases where a metal salt or a metal oxide is utilized as the raw material. Also, the Bi₁₂MO₂₀ precursor having a high purity are capable of being obtained.

With the first process for producing a photo-conductor layer for constituting a radiation imaging panel in accordance with the present invention, the mixed solution of the bismuth salt and the metal alkoxide is mixed together with the aqueous alkali solution, and the Bi₁₂MO₂₀ precursor is thereby obtained. Also, the thus obtained Bi₁₂MO₂₀ precursor is subjected to the molding processing, the thus molded Bi₁₂MO₂₀ precursor is subjected to the firing processing, and the photo-conductor layer is thereby produced. Therefore, the advantages over the conventional solid phase technique are capable of being obtained in that the particle diameter of the obtained particles is capable of being kept on the order of as small as a sub-micron size, and in that the packing density of Bi₁₂MO₂₀ in the photo-conductor layer is capable of being kept high. Accordingly, the effect of collecting the formed electric charges is capable of being enhanced, and electric noise is capable of being suppressed. As a result, graininess characteristics of the obtained image are capable of being enhanced, and the photo-conductor layer having a high sensitivity is capable of being obtained.

With the first process for producing a photo-conductor layer for constituting a radiation imaging panel in accordance with the present invention, wherein the molding processing of the Bi₁₂MO₂₀ precursor is performed with the CIP technique, the packing density is capable of being enhanced, and the effect of collecting the formed electric charges is capable of being enhanced even further.

With the first process for producing Bi₁₂MO₂₀ particles in accordance with the present invention, the mixed solution of the bismuth salt and the metal alkoxide is mixed together with the aqueous alkali solution, and the Bi₁₂MO₂₀ precursor is thereby obtained. Also, the thus obtained Bi₁₂MO₂₀ precursor is subjected to the heating processing in the alkaline liquid phase, and the Bi₁₂MO₂₀ particles are thereby obtained. Therefore, the purity of the metal is capable of being kept higher than the metal purity obtained in cases where a metal salt or a metal oxide is utilized as the raw material. Also, the Bi₁₂MO₂₀ particles having a high purity are capable of being obtained.

Further, the first process for producing Bi₁₂MO₂₀ particles in accordance with the present invention has the advantages described below over the conventional solid phase technique, wherein Bi₂O₃ and the metal oxide are subjected to the firing processing, and wherein the Bi₁₂MO₂₀ particles are thereby synthesized. Specifically, with the first process for producing Bi₁₂MO₂₀ particles in accordance with the present invention, the processing is performed in the liquid phase. Therefore, the reaction is caused to occur at a low temperature, and crystallization is capable of being performed in the liquid phase. Accordingly, abrupt crystal growth does not occur, and the Bi₁₂MO₂₀ particles having uniform composition and free from crystal defects are capable of being obtained.

With the second process for producing a photo-conductor layer for constituting a radiation imaging panel in accordance with the present invention, the photo-conductor layer is produced from the Bi₁₂MO₂₀ particles, which have a high purity and uniform composition. Therefore, the effect of collecting the formed electric charges is capable of being enhanced, and electric noise is capable of being suppressed. As a result, the graininess characteristics of the obtained image are capable of being enhanced, and the photo-conductor layer having a high sensitivity is capable of being obtained.

With the second process for producing Bi₁₂MO₂₀ particles in accordance with the present invention, the mixed solution of the bismuth salt and the metal alkoxide is mixed together with the aqueous alkali solution, and the Bi₁₂MO₂₀ precursor is thereby obtained. Also, the thus obtained Bi₁₂MO₂₀ precursor is subjected to the firing processing, and the Bi₁₂MO₂₀ particles are thereby obtained. Therefore, the purity of the metal is capable of being kept higher than the metal purity obtained in cases where a metal salt or a metal oxide is utilized as the raw material. Also, the Bi₁₂MO₂₀ particles having a high purity are capable of being obtained.

Further, the second process for producing Bi₁₂MO₂₀ particles in accordance with the present invention has the advantages described below over the conventional solid phase technique, wherein Bi₂O₃ and the metal oxide are subjected to the firing processing, and wherein the Bi₁₂MO₂₀ particles are thereby synthesized. Specifically, with the second process for producing Bi₁₂MO₂₀ particles in accordance with the present invention, the Bi₁₂MO₂₀ precursor, which has the uniform composition, is subjected to the firing processing. Therefore, the Bi₁₂MO₂₀ particles having the uniform composition are capable of being obtained.

With the third process for producing a photo-conductor layer for constituting a radiation imaging panel in accordance with the present invention, the photo-conductor layer is produced from the Bi₁₂MO₂₀ particles, which have a high purity and the uniform composition. Therefore, the effect of collecting the formed electric charges is capable of being enhanced, and electric noise is capable of being suppressed. As a result, the graininess characteristics of the obtained image are capable of being enhanced, and the photo-conductor layer having a high sensitivity is capable of being obtained.

The present invention will hereinbelow be described in further detail with reference to the accompanying drawings.

### BRIEF DESCRIPTION OF THE DRAWINGS

FIG. 1 is a sectional view showing an example of a radiation imaging panel, which comprises a photo-conductor layer produced with the process for producing a photo-conductor layer for constituting a radiation imaging panel in accordance with the present invention,

FIG. 2 is a schematic view showing a recording and read-out system, in which the radiation imaging panel of FIG. 1 is employed,

FIGS. 3A to 3D are explanatory views showing electric charge models for explanation of an electrostatic latent image recording stage in the recording and read-out system of FIG. 2,

FIGS. 4A to 4D are explanatory views showing electric charge models for explanation of an electrostatic latent image read-out stage in the recording and read-out system of FIG. 2,

FIG. 5 is an explanatory view showing a radiation detector and an AMA board, which are combined together,

FIG. 6 is an electric circuit diagram showing an equivalent circuit of the AMA board,

FIG. 7 is a sectional view showing a constitution at each of radiation detecting sections, each of which corresponds to one pixel,

FIG. 8 is a graph showing reflection spectrums of Bi₁₂TiO₂₀ particles obtained in Example 5 and Bi₁₂TiO₂₀ particles obtained in Comparative Example 4, and

FIG. 9 is a graph showing reflection spectrums of Bi₁₂TiO₂₀ particles obtained in Example 8 and Bi₁₂TiO₂₀ particles obtained in Comparative Example 7.

### DETAILED DESCRIPTION OF THE INVENTION

The process for producing a Bi₁₂MO₂₀ precursor in accordance with the present invention comprises the steps of: (i) preparing the mixed solution of the bismuth salt and the metal alkoxide, and (ii) mixing the mixed solution of the bismuth salt and the metal alkoxide together with the aqueous alkali solution, whereby the Bi₁₂MO₂₀ precursor, in which M represents at least one kind of element selected from the group consisting of Ge, Si, and Ti, is obtained. The bismuth salt should preferably be selected from the group consisting of bismuth nitrate and bismuth acetate. Preferable examples of the metal alkoxides include an alkoxide of Ge, an alkoxide of Si, and an alkoxide of Ti. Specifically, preferable examples of the metal alkoxides include Ge(O—CH₃)₄, Ge(O—C₂H₅)₄, Ge(O-i-C₃H₇)₄, Si(O—CH₃)₄, Si(O—C₂H₅)₄, Si(O-i-C₃H₇)₄, Ti(O—CH₃)₄, Ti(O—C₂H₅)₄, Ti(O-i-C₃H₇)₄, and Ti(O-n-C₄H₉)₄.

With the process for producing a Bi₁₂MO₂₀ precursor in accordance with the present invention, the mixed solution of the bismuth salt and the metal alkoxide is mixed together with the aqueous alkali solution, and the Bi₁₂MO₂₀ precursor is thereby obtained. In the process for producing a Bi₁₂MO₂₀ precursor in accordance with the present invention (and in the first and second processes for producing Bi₁₂MO₂₀ particles in accordance with the present invention, which will be described later), in such cases, the aqueous alkali solution may be added to the mixed solution of the bismuth salt and the metal alkoxide. Alternatively, the mixed solution of the bismuth salt and the metal alkoxide may be added to the aqueous alkali solution.

Preferable examples of solvents, which may be utilized for the mixing of the bismuth salt and the metal alkoxide, include methoxy ethanol, ethoxy ethanol, acetic acid, nitric acid, and glycerin. Preferable examples of the aqueous alkali solutions include an aqueous LiOH solution, an aqueous NaOH solution, an aqueous KOH solution, an aqueous NH₃ solution, and an aqueous ((CₙH₂₊₁)₄NOH solution.

In order for the photo-conductor layer to be produced, the obtained Bi₁₂MO₂₀ precursor is subjected to the molding processing. With the molding processing, the obtained Bi₁₂MO₂₀ precursor is formed at least into a predetermined shape. A preferable technique for the molding processing is the CIP technique. With the CIP technique, the Bi₁₂MO₂₀ precursor is encapsulated in a mold, such as a rubber bag, which has a small deformation resistance, a hydraulic pressure is exerted upon the mold, and compression molding is thus performed without directivity. The pressure (i.e., the hydraulic pressure), at which the molding processing with the CIP technique is performed, should preferably fall within the range of 100 MPa to 700 MPa.

For the molding processing, it is also possible to employ one of various known techniques, such as a hot isostatic pressing technique (HIP technique), a hot pressing technique, and a green sheet technique. With the HIP technique, a high temperature of several hundreds of degrees centigrade and an isostatic pressure falling within the range of several tens of MPa to several hundreds of MPa are simultaneously exerted upon the Bi₁₂MO₂₀ precursor. With the hot pressing technique, pressing with a pressure from only a uniaxial direction is performed on the Bi₁₂MO₂₀ precursor. With the green sheet technique, the Bi₁₂MO₂₀ precursor is mixed with a binder, and the thus obtained coating composition is subjected to coating processing, a green sheet (i.e., a film containing the binder) being thereby formed. Also, the thus formed green sheet is subjected to sintering processing for removing the binder from the film and sintering the Bi₁₂MO₂₀ precursor.

As described above, with the process for producing a Bi₁₂MO₂₀ precursor in accordance with the present invention, the mixed solution of the bismuth salt and the metal alkoxide is mixed together with the aqueous alkali solution, and the Bi₁₂MO₂₀ precursor is thereby obtained. Therefore, the purity of the metal is capable of being kept higher than the metal purity obtained in cases where a metal salt or a metal oxide is utilized as the raw material. Also, the Bi₁₂MO₂₀ precursor having a high purity are capable of being obtained.

In cases where the photo-conductor layer is produced by use of the Bi₁₂MO₂₀ precursor, which has a high purity and uniform composition, the effect of collecting the formed electric charges is capable of being enhanced, and electric noise is capable of being suppressed. As a result, the graininess characteristics of the obtained image are capable of being enhanced, and the photo-conductor layer having a high sensitivity is capable of being obtained. In cases where the molding processing of the Bi₁₂MO₂₀ precursor is performed with the CIP technique, the packing density is capable of being enhanced, and the effect of collecting the formed electric charges is capable of being enhanced even further.

The first process for producing Bi₁₂MO₂₀ particles in accordance with the present invention comprises the steps of: (i) preparing the mixed solution of the bismuth salt and the metal alkoxide, (ii) mixing the mixed solution of the bismuth salt and the metal alkoxide together with the aqueous alkali solution, the Bi₁₂MO₂₀ precursor, in which M represents at least one kind of element selected from the group consisting of Ge, Si, and Ti, being thereby obtained, and (iii) subjecting the thus obtained Bi₁₂MO₂₀ precursor to the heating processing in the alkaline liquid phase, whereby the Bi₁₂MO₂₀ particles are obtained. The bismuth salt and the metal alkoxide may be selected from the preferable examples of the bismuth salts and the metal alkoxides described above with respect to the process for producing a Bi₁₂MO₂₀ precursor in accordance with the present invention.

In the first process for producing Bi₁₂MO₂₀ particles in accordance with the present invention, the solvent, which may be utilized for the mixing of the bismuth salt and the metal alkoxide, may be selected from the preferable examples of the solvents described above with respect to the process for producing a Bi₁₂MO₂₀ precursor in accordance with the present invention.

With the first process for producing Bi₁₂MO₂₀ particles in accordance with the present invention, after the Bi₁₂MO₂₀ precursor has been obtained, the thus obtained Bi₁₂MO₂₀ precursor is subjected to the heating processing in the alkaline liquid phase, and the Bi₁₂MO₂₀ particles are thereby obtained. In such cases, the aqueous alkali solution described above may further be added to the reaction mixture containing the Bi₁₂MO₂₀ precursor, and the liquid-phase heating processing may thus be performed. The liquid-phase heating processing should preferably be the processing for heating in the liquid phase, e.g. the hydrothermal processing. Alternatively, the liquid-phase heating processing may be performed with reflux. The liquid-phase heating processing should preferably be performed at a temperature falling within the range of 50° C. to 250° C. The temperature, at which the liquid-phase heating processing is performed, may vary in accordance with the selection of the kind of the bismuth salt, the selection of the kind of the metal alkoxide, the selection of the kind of the aqueous alkali solution, and the combination of the bismuth salt, the metal alkoxide, and the aqueous alkali solution. In cases where the pH value of the alkalinity is set at a high value, the temperature, at which the liquid-phase heating processing is performed, is capable of being set at a low temperature.

As the technique for producing the photo-conductor layer by use of the Bi₁₂MO₂₀ particles having been obtained with the first process for producing Bi₁₂MO₂₀ particles in accordance with the present invention, it is possible to employ one of various known techniques, such as a binder coating technique, an aerosol deposition technique, a press sintering technique, the CIP technique, the HIP technique, the hot pressing technique, and the green sheet technique. With the binder coating technique, the Bi₁₂MO₂₀ particles are mixed with a binder, the thus obtained coating composition is applied onto a substrate, and the resulting coating layer is dried. With the aerosol deposition technique, the Bi₁₂MO₂₀ particles are caused to fly by a carrier gas in a vacuum, and the carrier gas containing the Bi₁₂MO₂₀ particles is blown against a substrate in a vacuum. In this manner, the Bi₁₂MO₂₀ particles are deposited on the substrate. With the press sintering technique, the Bi₁₂MO₂₀ particles are pressed at a high pressure by use of a pressing machine, and a film of the Bi₁₂MO₂₀ particles is thus formed. Also, the thus formed film is subjected to sintering processing. With the CIP technique, the Bi₁₂MO₂₀ particles are encapsulated in a mold, such as a rubber bag, which has a small deformation resistance, a hydraulic pressure is exerted upon the mold, and compression molding is thus performed without directivity. With the HIP technique, a high temperature of several hundreds of degrees centigrade and an isostatic pressure falling within the range of several tens of MPa to several hundreds of MPa are simultaneously exerted upon the Bi₁₂MO₂₀ particles. With the hot pressing technique, pressing at a high temperature of several hundreds of degrees centigrade and with a pressure from only a uniaxial direction is performed on the Bi₁₂MO₂₀ particles. With the green sheet technique, the Bi₁₂MO₂₀ particles are mixed with a binder, and the thus obtained coating composition is subjected to coating processing, a green sheet (i.e., a film containing the binder) being thereby formed. Also, the thus formed green sheet is subjected to sintering processing for removing the binder from the film and sintering the Bi₁₂MO₂₀ particles.

Preferable examples of the binders, which may be utilized for the binder coating technique described above, include nitrocellulose, ethylcellulose, cellulose acetate, a vinylidene chloride-vinyl chloride copolymer, a polyalkyl methacrylate, a polyurethane, a polyvinylbutyral, a polyester, a polystyrene, a polyamide, a polyethylene, a polyvinyl chloride, a polyvinyl acetate, a vinyl chloride-vinyl acetate copolymer, a polyvinyl alcohol, and a linear polyester.

Preferable examples of the binders, which may be utilized for the green sheet technique described above, include cellulose acetate, a polyalkyl methacrylate, a polyvinyl alcohol, and a polyvinyl butyral.

As described above, with the first process for producing Bi₁₂MO₂₀ particles in accordance with the present invention, the mixed solution of the bismuth salt and the metal alkoxide is mixed together with the aqueous alkali solution, and the Bi₁₂MO₂₀ precursor is thereby obtained. Also, the thus obtained Bi₁₂MO₂₀ precursor is subjected to the heating processing in the alkaline liquid phase, and the Bi₁₂MO₂₀ particles are thereby obtained. Therefore, the purity of the metal is capable of being kept higher than the metal purity obtained in cases where a metal salt or a metal oxide is utilized as the raw material. Also, the Bi₁₂MO₂₀ particles having a high purity are capable of being obtained.

Further, with the first process for producing Bi₁₂MO₂₀ particles in accordance with the present invention, the processing is performed in the liquid phase. Therefore, the reaction is caused to occur at a low temperature, and crystallization is capable of being performed in the liquid phase. Accordingly, abrupt crystal growth does not occur, and the Bi₁₂MO₂₀ particles having uniform composition and free from crystal defects are capable of being obtained.

In cases where the photo-conductor layer is produced from the Bi₁₂MO₂₀ particles, which have a high purity and the uniform composition and which have been obtained with the first process for producing Bi₁₂MO₂₀ particles in accordance with the present invention, the effect of collecting the formed electric charges is capable of being enhanced, and electric noise is capable of being suppressed. As a result, the graininess characteristics of the obtained image are capable of being enhanced, and the photo-conductor layer having a high sensitivity is capable of being obtained.

The second process for producing Bi₁₂MO₂ particles in accordance with the present invention comprises the steps of: (i) preparing the mixed solution of the bismuth salt and the metal alkoxide, (ii) mixing the mixed solution of the bismuth salt and the metal alkoxide together with the aqueous alkali solution, the Bi₁₂MO₂₀ precursor, in which M represents at least one kind of element selected from the group consisting of Ge, Si, and Ti, being thereby obtained, and (iii) subjecting the thus obtained Bi₁₂MO₂₀ precursor to the firing processing, whereby the Bi₂MO₂₀ particles are obtained. The bismuth salt and the metal alkoxide may be selected from the preferable examples of the bismuth salts and the metal alkoxides described above with respect to the process for producing a Bi₁₂MO₂₀ precursor in accordance with the present invention.

In the second process for producing Bi₁₂MO₂₀ particles in accordance with the present invention, the solvent, which may be utilized for the mixing of the bismuth salt and the metal alkoxide, may be selected from the preferable examples of the solvents described above with respect to the process for producing a Bi₁₂MO₂₀ precursor in accordance with the present invention.

With the second process for producing Bi₁₂MO₂₀ particles in accordance with the present invention, the mixed solution of the bismuth salt and the metal alkoxide is mixed together with the aqueous alkali solution, and the Bi₁₂MO₂₀ precursor is thereby obtained. Thereafter, the thus obtained Bi₁₂MO₂₀ precursor is subjected to the firing processing, and the Bi₁₂MO₂₀ particles are thereby obtained. The firing processing should preferably be performed at a temperature falling within the range of 500° C. to 800° C. The temperature, at which the firing processing is performed, may vary in accordance with the selection of the kind of the bismuth salt, the selection of the kind of the metal alkoxide, the selection of the kind of the aqueous alkali solution, and the combination of the bismuth salt, the metal alkoxide, and the aqueous alkali solution.

As the technique for producing the photo-conductor layer by use of the Bi₁₂MO₂₀ particles having been obtained with the second process for producing Bi₁₂MO₂₀ particles in accordance with the present invention, it is possible to employ one of the various known techniques for producing the photo-conductor layer, which are described above with respect to the first process for producing Bi₁₂MO₂₀ particles in accordance with the present invention.

As described above, with the second process for producing Bi₁₂MO₂₀ particles in accordance with the present invention, the mixed solution of the bismuth salt and the metal alkoxide is mixed together with the aqueous alkali solution, and the Bi₁₂MO₂₀ precursor is thereby obtained. Also, the thus obtained Bi₁₂MO₂₀ precursor is subjected to the firing processing, and the Bi₁₂MO₂₀ particles are thereby obtained. Therefore, the purity of the metal is capable of being kept higher than the metal purity obtained in cases where a metal salt or a metal oxide is utilized as the raw material. Also, the Bi₁₂MO₂₀ particles having a high purity are capable of being obtained.

Further, with the second process for producing Bi₁₂MO₂₀ particles in accordance with the present invention, the Bi₁₂MO₂₀ precursor, which is obtained from the mixing of the mixed solution of the bismuth salt and the metal alkoxide together with the aqueous alkali solution, has the uniform composition. Also, the Bi₁₂MO₂, precursor having the uniform composition is subjected to the firing processing. Therefore, the Bi₁₂MO₂₀ particles having the uniform composition are capable of being obtained.

In cases where the photo-conductor layer is produced from the Bi₁₂MO₂₀ particles, which have a high purity and the uniform composition and which have been obtained with the second process for producing Bi₁₂MO₂₀ particles in accordance with the present invention, the effect of collecting the formed electric charges is capable of being enhanced, and electric noise is capable of being suppressed. As a result, the graininess characteristics of the obtained image are capable of being enhanced, and the photo-conductor layer having a high sensitivity is capable of being obtained.

Radiation imaging panels, which are produced by use of the Bi₁₂MO₂₀ precursor or the Bi₁₂MO₂₀ particles having been obtained with each of the production processes in accordance with the present invention, will be described hereinbelow.

Ordinarily, radiation imaging panels may be classified into a direct conversion type, in which the radiation energy is directly converted into electric charges, and the thus formed electric charges are accumulated, and an indirect conversion type, in which the radiation energy is converted into light by use of a scintillator, such as CsI, the thus obtained light is then converted into electric charges by use of a-Si photodiodes, and the thus formed electric charges are accumulated. The photo-conductor layer, which is produced with each of the production processes in accordance with the present invention, is employed for the direct conversion type of the radiation imaging panel. The photo-conductor layer, which is produced with each of the production processes in accordance with the present invention, may be employed for the radiation, such as X-rays, γ-rays, and α-rays.

The photo-conductor layer, which is produced by use of the Bi₁₂MO₂₀ precursor or the Bi₁₂MO₂₀ particles having been obtained with each of the production processes in accordance with the present invention, may be employed for an optical read-out technique, in which the read-out operation is performed by use of a radiation image detector utilizing a semiconductor material capable of generating the electric charges when being exposed to light. The photo-conductor layer, which is produced by use of the Bi₁₂MO₂₀ precursor or the Bi₁₂MO₂₀ particles having been obtained with each of the production processes in accordance with the present invention, may also be employed for a TFT technique. With the TFT technique, the electric charges having been generated with the irradiation of the radiation are accumulated, and the accumulated electric charges are read through an operation, in which an electric switch, such as a thin film transistor (TFT), is turned on and off with respect to each of pixels.

Firstly, by way of example, the radiation imaging panel employed for the optical read-out technique will be described hereinbelow.

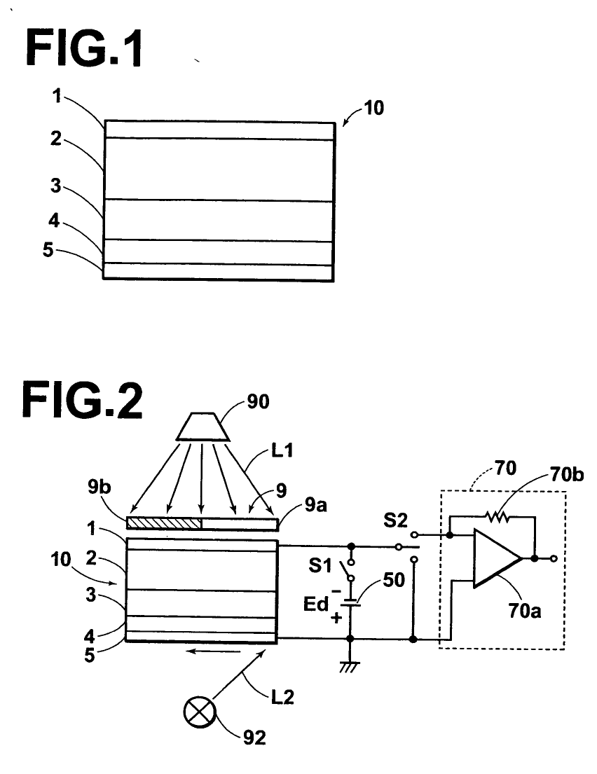

FIG. 1 is a sectional view showing an example of a radiation imaging panel, which comprises a photo-conductor layer produced with the process for producing a photo-conductor layer for constituting a radiation imaging panel in accordance with the present invention.

With reference to FIG. 1, a radiation imaging panel 10 comprises a first electrically conductive layer 1, which has transmissivity to recording radiation L1 described later. The radiation imaging panel 10 also comprises a recording radio-conductive layer 2, which exhibits electrical conductivity when it is exposed to the radiation L1 having passed through the first electrically conductive layer 1. The radiation imaging panel 10 further comprises a charge transporting layer 3, which acts approximately as an insulator with respect to electric charges (latent image polarity charges, e.g. negative charges) having a polarity identical with the polarity of electric charges occurring in the first electrically conductive layer 1, and which acts approximately as a conductor with respect to electric charges (transported polarity charges, positive charges in this example) having a polarity opposite to the polarity of the electric charges occurring in the first electrically conductive layer 1. The radiation imaging panel 10 still further comprises a reading photo-conductor layer 4, which exhibits electrical conductivity when it is exposed to reading light L2 described later, and a second electrically conductive layer 5 having transmissivity to the reading light L2. The first electrically conductive layer 1, the recording radio-conductive layer 2, the charge transporting layer 3, the reading photo-conductor layer 4, and the second electrically conductive layer 5 are overlaid in this order.

As each of the first electrically conductive layer 1 and the second electrically conductive layer 5, a film of an electrically conductive substance (tin dioxide film, or the like) uniformly coated on a transparent glass plate may be employed.

The charge transporting layer 3 may be constituted of one of various materials, which have the characteristics such that the difference between the mobility of the negative electric charges occurring in the first electrically conductive layer 1 and the mobility of the positive electric charges is large. The charge transporting layer 3 should preferably be constituted of, for example, an organic compound, such as a poly-N-vinylcarbazole (PVK), N,N′-diphenyl-N,N′-bis(3-methylphenyl)-[1,1′-biphenyl]-4,4′-diamine (TPD), or a disk-shaped liquid crystal; or a semiconductor substance, such as a polymer (polycarbonate, polystyrene, PVK) dispersion of TPD, or a-Se doped with 10 ppm to 200 ppm of Cl. In particular, the organic compound (PVK, TPD, or the disk-shaped liquid crystal) has light insensitivity and is therefore preferable. Also, since the permittivity is ordinarily low, the capacity of the charge transporting layer 3 and the capacity of the reading photo-conductor layer 4 become small, and the signal take-out efficiency at the time of readout is capable of being kept high.

The reading photo-conductor layer 4 should preferably be constituted of, for example, a photo-conductive material containing, as a principal constituent, at least one substance selected from the group consisting of a-Se, Se—Te, Se—As—Te, metal-free phthalocyanine, metallo-phthalocyanine, magnesium phthalocyanine (MgPc), phase II of vanadyl phthalocyanine (VoPc), and copper phthalocyanine (CuPc).

As the recording radio-conductive layer 2, the photo-conductor layer, which is constituted of a Bi₁₂MO₂₀ sintered film and is produced with the production process in accordance with the present invention, is employed. Specifically, the photo-conductor layer, which is produced with the production process in accordance with the present invention, is the recording radio-conductive layer.

The optical read-out technique for reading out the electrostatic latent image will hereinbelow be described briefly.

FIG. 2 is a schematic view showing a recording and read-out system (i.e., a combination of an electrostatic latent image recording apparatus and an electrostatic latent image read-out apparatus), in which the radiation imaging panel 10 of FIG. 1 is employed. With reference to FIG. 2, the recording and read-out system comprises the radiation imaging panel 10 and recording irradiation means 90. The recording and read-out system also comprises an electric power source 50 and electric current detecting means 70. The recording and read-out system further comprises read-out exposure means 92, connection means S1, and connection means S2. The electrostatic latent image recording apparatus is constituted of the radiation imaging panel 10, the electric power source 50, the recording irradiation means 90, and the connection means S1. The electrostatic latent image read-out apparatus is constituted of the radiation imaging panel 10, the electric current detecting means 70, and the connection means S2.

The first electrically conductive layer 1 of the radiation imaging panel 10 is connected via the connection means S1 to a negative pole of the electric power source 50. The first electrically conductive layer 1 of the radiation imaging panel 10 is also connected to one end of the connection means S2. One terminal of the other end of the connection means S2 is connected to the electric current detecting means 70. The second electrically conductive layer 5 of the radiation imaging panel 10, a positive pole of the electric power source 50, and the other terminal of the other end of the connection means S2 are grounded. The electric current detecting means 70 comprises a detection amplifier 70a, which is constituted of an operational amplifier, and a feedback resistor 70b. The electric current detecting means 70 thus constitutes a current-to-voltage converting circuit.

An object 9 lies at the top surface of the first electrically conductive layer 1. The object 9 has a transmissive region 9a, which has the transmissivity to the radiation L1, and a light blocking region 9b, which does not have the transmissivity to the radiation L1. The recording irradiation means 90 uniformly irradiates the radiation L1 to the object 9. With the read-out exposure means 92, the reading light L2, such as an infrared laser beam, an LED light, or an EL light, is scanned in the direction indicated by the arrow in FIG. 2. The reading light L2 should preferably has a beam shape having been converged into a small beam diameter.

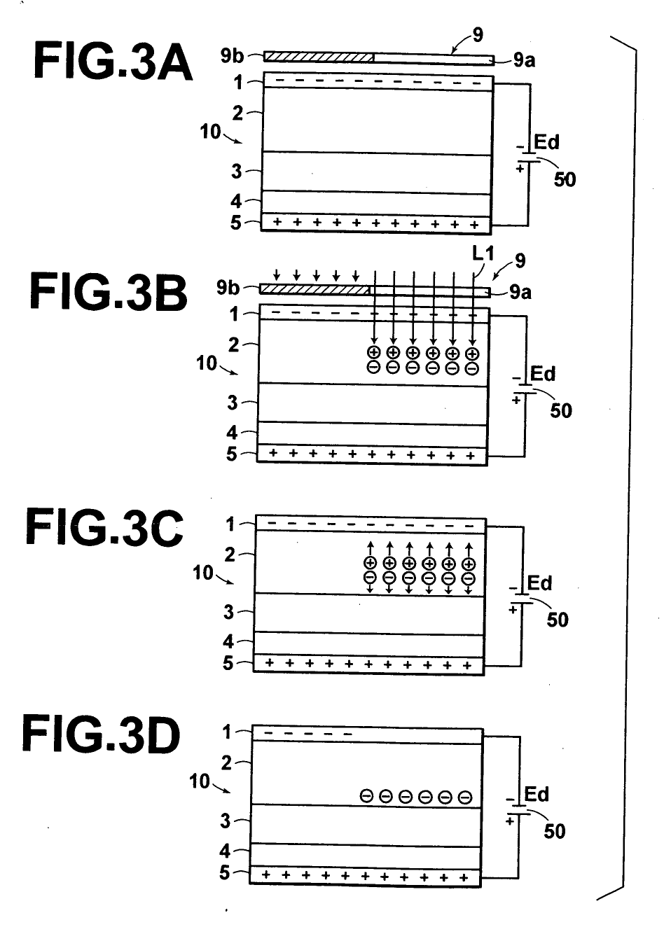

An electrostatic latent image recording stage in the recording and read-out system of FIG. 2 will be described hereinbelow with reference to FIGS. 3A to 3D. FIGS. 3A to 3D are explanatory views showing electric charge models for explanation of an electrostatic latent image recording stage in the recording and read-out system of FIG. 2. The connection means S2 illustrated in FIG. 2 is set in an open state (in which the connection means S2 is not connected to the ground nor to the electric current detecting means 70). Also, as illustrated in FIG. 3A, the connection means S1 illustrated in FIG. 2 is set in the on state, and a d.c. voltage Ed supplied by the electric power source 50 is applied between the first electrically conductive layer 1 and the second electrically conductive layer 5. As a result, the negative charges occur in the first electrically conductive layer 1, and the positive charges occur in the second electrically conductive layer 5. In this manner, a parallel electric field is formed between the first electrically conductive layer 1 and the second electrically conductive layer 5.

Thereafter, as illustrated in FIG. 3B, the radiation L1 is uniformly irradiated from the recording irradiation means 90 toward the object 9. The radiation L1, which has been produced by the recording irradiation means 90, passes through the transmissive region 9a of the object 9. The radiation L1 then passes through the first electrically conductive layer 1 and impinges upon the recording radio-conductive layer 2. When the recording radio-conductive layer 2 receives the radiation L1 having passed through the first electrically conductive layer 1, the recording radio-conductive layer 2 exhibits the electrical conductivity. The characteristics of the recording radio-conductive layer 2 for exhibiting the electrical conductivity are capable of being found from the characteristics in that the recording radio-conductive layer 2 acts as a variable resistor exhibiting a resistance value variable in accordance with the dose of the radiation L1. The resistance value depends upon the occurrence of electric charge pairs of electrons (negative charges) and holes (positive charges) due to the radiation L1. In cases where the dose of the radiation L1, which has passed through the object 9, is small, a large resistance value is exhibited. In FIG. 3B, the negative charges (−) formed by the radiation L1 are represented by “−” surrounded by the “◯” mark, and the positive charges (+) formed by the radiation L1 are represented by “+” surrounded by the “◯” mark.

As illustrated in FIG. 3C, the positive charges, which have occurred in the recording radio-conductive layer 2, quickly migrate through the recording radio-conductive layer 2 toward the first electrically conductive layer 1. Also, as illustrated in FIG. 3D, the positive charges, which have migrated through the recording radio-conductive layer 2 toward the first electrically conductive layer 1, undergo charge re-combination with the negative charges, which have been formed in the first electrically conductive layer 1. The charge re-combination occurs at the interface between the first electrically conductive layer 1 and the recording radio-conductive layer 2, and the positive charges described above disappear.

Also, as illustrated in FIG. 3C, the negative charges, which have occurred in the recording radio-conductive layer 2, migrate through the recording radio-conductive layer 2 toward the charge transporting layer 3. The charge transporting layer 3 acts as the insulator with respect to the electric charges (in this example, the negative charges) having the polarity identical with the polarity of the electric charges occurring in the first electrically conductive layer 1. Therefore, as illustrated in FIG. 3D, the negative charges, which have migrated through the recording radio-conductive layer 2 toward the charge transporting layer 3, cease at the interface between the recording radio-conductive layer 2 and the charge transporting layer 3 and are accumulated at the interface between the recording radio-conductive layer 2 and the charge transporting layer 3. The quantity of the electric charges, which are thus accumulated, is defined by the quantity of the negative charges occurring in the recording radio-conductive layer 2, i.e. the dose of the radiation L1 having passed through the object 9.

The radiation L1 does not pass through the light blocking region 9b of the object 9. Therefore, as illustrated in FIGS. 3B, 3C, and 3D, a change does not occur at the region of the radiation imaging panel 10, which region is located under the light blocking region 9b of the object 9. In the manner described above, in cases where the radiation L1 is irradiated to the object 9, electric charges in accordance with the object image are capable of being accumulated at the interface between the recording radio-conductive layer 2 and the charge transporting layer 3. The object image, which is formed with the thus accumulated electric charges, is referred to as the electrostatic latent image.

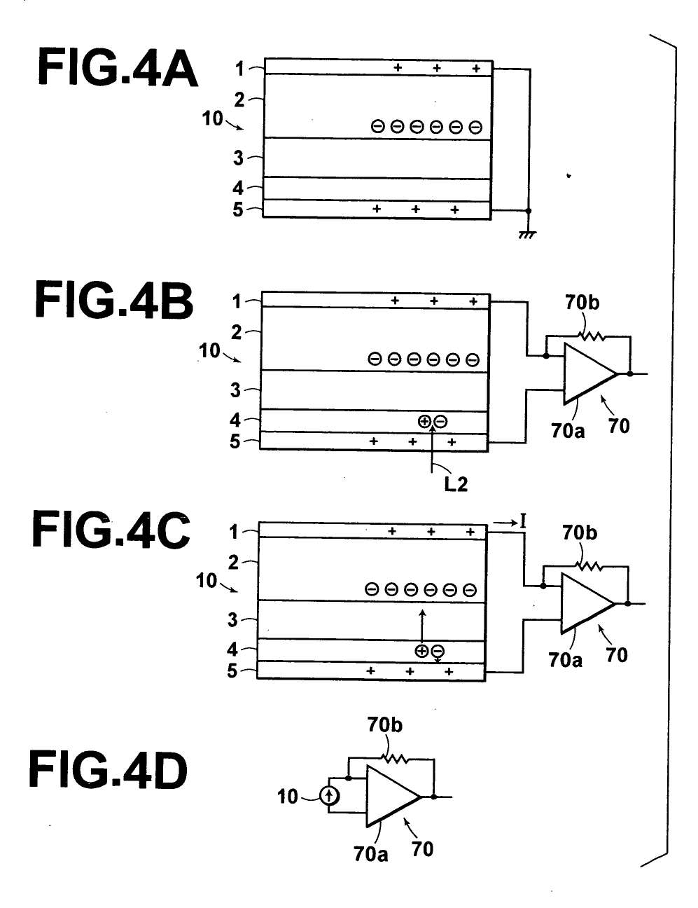

An electrostatic latent image read-out stage in the recording and read-out system of FIG. 2 will be described hereinbelow with reference to FIGS. 4A to 4D. FIGS. 4A to 4D are explanatory views showing electric charge models for explanation of an electrostatic latent image read-out stage in the recording and read-out system of FIG. 2. The connection means S1 illustrated in FIG. 2 is set in the open state, and the supply of the electric power is ceased. Also, as illustrated in FIG. 4A, the connection means S2 illustrated in FIG. 2 is connected to the ground side. In this manner, the first electrically conductive layer 1 and the second electrically conductive layer 5 of the radiation imaging panel 10, on which the electrostatic latent image has been recorded, are set at the identical electric potential, and re-arrangement of the electric charges is performed. Thereafter, the connection means S2 is connected to the side of the electric current detecting means 70.

Also, as illustrated in FIG. 4B, with the read-out exposure means 92, the scanning with the reading light L2 is performed from the side of the second electrically conductive layer 5 of the radiation imaging panel 10. The reading light L2 impinging upon the second electrically conductive layer 5 passes through the second electrically conductive layer 5 and impinges upon the reading photo-conductor layer 4. When the reading photo-conductor layer 4 is exposed to the reading light L2, which has passed through the second electrically conductive layer 5, the reading photo-conductor layer 4 exhibits the electrical conductivity in accordance with the scanning exposure. As in the cases of the characteristics of the recording radio-conductive layer 2 for exhibiting the electrical conductivity due to the occurrence of the pairs of the positive and negative charges when the recording radio-conductive layer 2 is exposed to the radiation L1, the characteristics of the reading photo-conductor layer 4 for exhibiting the electrical conductivity depend upon the occurrence of the pairs of the positive and negative charges when the reading photo-conductor layer 4 is exposed to the reading light L2. As in the cases of the electrostatic latent image recording stage, in FIG. 4B, the negative charges (−) formed by the reading light L2 are represented by “−” surrounded by the “◯” mark, and the positive charges (+) formed by the reading light L2 are represented by “+” surrounded by the “◯” mark.

The charge transporting layer 3 acts as the electrical conductor with respect to the positive charges. Therefore, as illustrated in FIG. 4C, the positive charges, which have occurred in the reading photo-conductor layer 4, quickly migrate through the charge transporting layer 3 by being attracted by the negative charges, which have been accumulated at the interface between the recording radio-conductive layer 2 and the charge transporting layer 3. The positive charges, which have thus migrated through the charge transporting layer 3, undergo the charge re-combination with the accumulated negative charges at the interface between the recording radio-conductive layer 2 and the charge transporting layer 3 and disappear. Also, as illustrated in FIG. 4C, the negative charges, which have occurred in the reading photo-conductor layer 4, undergo the charge re-combination with the positive charges of the second electrically conductive layer 5 and disappear. The reading photo-conductor layer 4 is scanned with the reading light L2 having a sufficient optical intensity, and all of the accumulated electric charges, which have been accumulated at the interface between the recording radio-conductive layer 2 and the charge transporting layer 3, i.e. the electrostatic latent image, disappear through the charge re-combination. The disappearance of the electric charges, which have been accumulated in the radiation imaging panel 10, means the state, in which an electric current I flows across the radiation imaging panel 10 due to the migration of the electric charges. The state, in which the electric current I flows across the radiation imaging panel 10 due to the migration of the electric charges, is capable of being represented by an equivalent circuit illustrated in FIG. 4D, in which the radiation imaging panel 10 is represented by the electric current source having the electric current quantity depending upon the quantity of the accumulated electric charges.

As described above, the scanning of the radiation imaging panel 10 with the reading light L2 is performed, and the electric current flowing across the radiation imaging panel 10 is detected. In this manner, the quantity of the accumulated electric charges, which have been accumulated at each of scanned regions (corresponding to pixels), is capable of being detected. The electrostatic latent image is thus capable of being read out. The operations of the radiation detecting section are described in, for example, Japanese Unexamined Patent Publication No. 2000-105297.

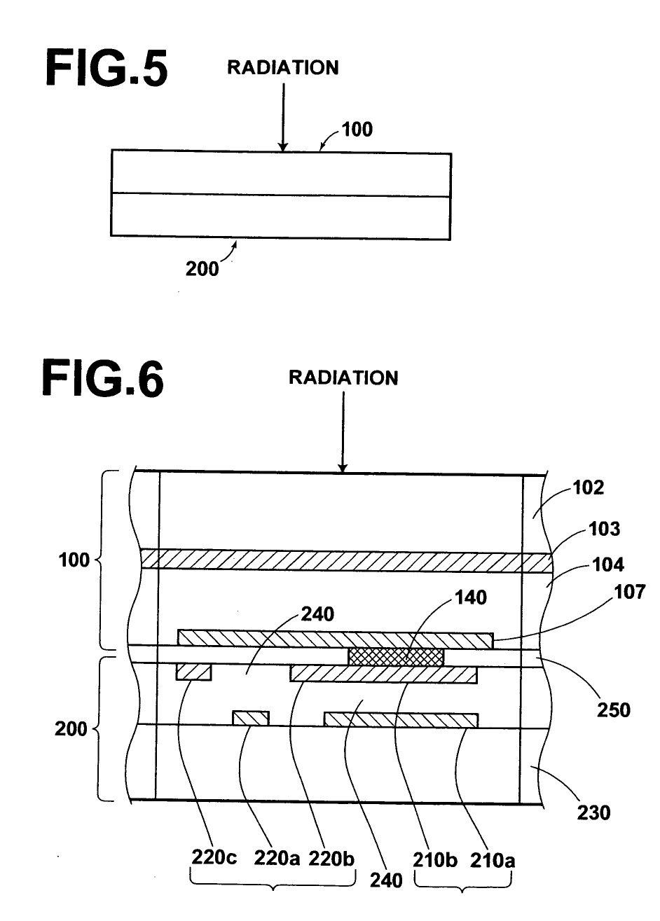

The TFT type of the radiation imaging panel will be described hereinbelow. As illustrated in FIG. 5, the TFT type of the radiation imaging panel has a structure, in which a radiation detecting section 100 and an active matrix array board (AMA board) 200 has been joined together. As illustrated in FIG. 6, the radiation detecting section 100 comprises a common electrode 103 for application of a bias voltage. The radiation detecting section 100 also comprises a photo-conductor layer 104, which is sensitive to the radiation to be detected and forms carriers constituted of electron-hole pairs. The radiation detecting section 100 further comprises a detection electrode 107 for collecting the carriers. The common electrode 103, the photo-conductor layer 104, and the detection electrode 107 are overlaid in this order from the radiation incidence side. A radiation detecting section support 102 may be located as a top layer on the common electrode 103.

The photo-conductor layer 104 is the photo-conductor layer, which is produced with the production process in accordance with the present invention. Each of the common electrode 103 and the detection electrode 107 may be constituted of an electrically conductive material, such as indium tin oxide (ITO), Au, or Pt. In accordance with the polarity of the bias voltage, a hole injection blocking layer or an electron injection blocking layer may be appended to the common electrode 103 or the detection electrode 107.

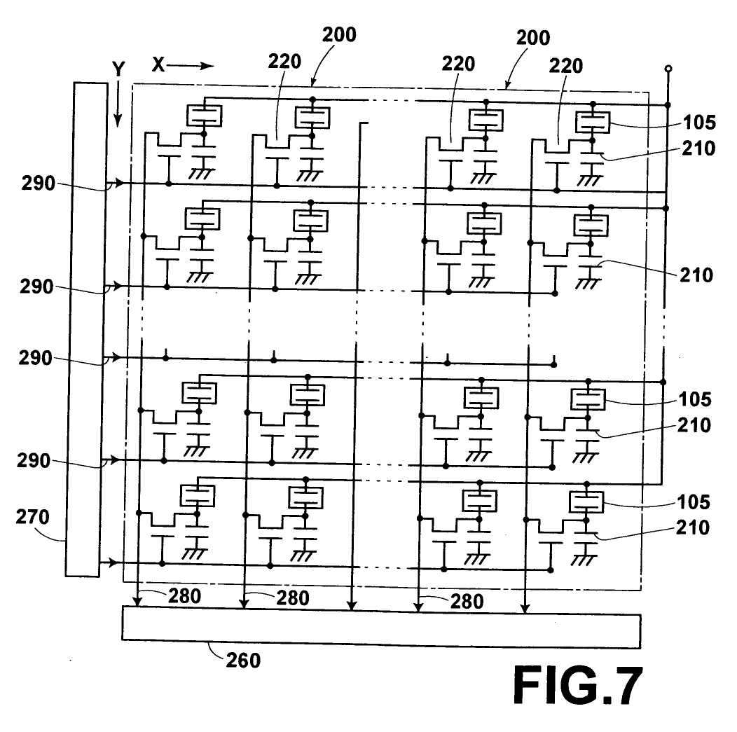

The constitution of the AMA board 200 will hereinbelow be described briefly. As illustrated in FIG. 7, the AMA board 200 comprises capacitors 210, 210, . . . acting as charge accumulating capacitors and TFT's 220, 220, . . . acting as switching devices. One capacitor 210 and one TFT 220 are located for each of radiation detecting sections 105, 105, . . . , which correspond respectively to the pixels. On the radiation detecting section support 102, in accordance with the necessary pixels, the radiation detecting sections 105, 105, . . . corresponding to the pixels are arrayed in two-dimensional directions in a pattern of a matrix comprising approximately 1,000˜3,000 rows×1,000˜3,000 columns. Also, the AMA board 200 comprises the same number of the combinations of the capacitor 210 and the TFT 220 as the number of the pixels are arrayed in two-dimensional directions in the same matrix patter as that described above. The electric charges, which have occurred in the photo-conductor layer 104, are accumulated in each of the capacitors 210, 210, . . . and act as the electrostatic latent image corresponding to the optical read-out technique. With the TFT technique, the electrostatic latent image having been formed with the radiation is kept at the charge accumulating capacitors.

The specific constitutions of each of the capacitors 210, 210, . . . and each of the TFT's 220, 220, . . . of the AMA board 200 are illustrated in FIG. 6. Specifically, an AMA board substrate 230 is constituted of an electrical insulator. A grounding side electrode 210a of the capacitor 210 and a gate electrode 220a of the TFT 220 are formed on the surface of the AMA board substrate 230. Above the grounding side electrode 210a of the capacitor 210 and the gate electrode 220a of the TFT 220, a connection side electrode 210b of the capacitor 210 is formed via an insulating film 240. Also, above the grounding side electrode 210a of the capacitor 210 and the gate electrode 220a of the TFT 220, a source electrode 220b and a drain electrode 220c of the TFT 220 are formed via the insulating film 240. Further, the top surface of the AMA board 200 is covered with a protective insulating film 250. The connection side electrode 210b of the capacitor 210 and the source electrode 220b of the TFT 220 are connected with each other and are formed together with each other. The insulating film 240 constitutes both the capacitor insulating film of the capacitor 210 and the gate insulating film of the TFT 220. The insulating film 240 may be constituted of, for example, a plasma SiN film. The AMA board 200 may be produced by use of a thin film forming technique or a fine processing technique, which is ordinarily employed for the production of a liquid crystal display board.

The joining of the radiation detecting section 100 and the AMA board 200 will be described hereinbelow. Specifically, the position of the detection electrode 107 and the position of the connection side electrode 210b of the capacitor 210 are matched with each other. In this state, the radiation detecting section 100 and the AMA board 200 are laminated together by adhesion under heating and under pressure with an anisotropic electrically conductive film (ACF) intervening therebetween. The ACF contains electrically conductive particles, such as silver particles, and has the electrical conductivity only in the thickness direction. In this manner, the radiation detecting section 100 and the AMA board 200 are mechanically combined with each other. At the same time, the detection electrode 107 and the connection side electrode 210b are electrically connected with each other by an intervening conductor section 140.

Also, the AMA board 200 is provided with a read-out actuating circuit 260 and a gate actuating circuit 270. As illustrated in FIG. 7, the read-out actuating circuit 260 is connected to each of read-out wiring lines (read-out address lines) 280, 280, . . . Each of the read-out wiring lines 280, 280, . . . extends in the vertical (Y) direction and connects the drain electrodes 220c, 220c, . . . of the TFT's 220, 220, . . . , which are arrayed along an identical column. The gate actuating circuit 270 is connected to each of read-out wiring lines (gate address lines) 290, 290, . . . Each of the read-out wiring lines 290, 290, . . . extends in the horizontal (X) direction and connects the gate electrodes 220a, 220a, . . . of the TFT's 220, 220, . . . , which are arrayed along an identical row. Though not shown, in the read-out actuating circuit 260, one pre-amplifier (one electric charge-to-voltage converter) is connected to each of the read-out wiring lines 280, 280, . . . In this manner, the AMA board 200 is connected to the read-out actuating circuit 260 and the gate actuating circuit 270. Alternatively, the read-out actuating circuit 260 and the gate actuating circuit 270 may be formed into an integral body within the AMA board 200.

The radiation detecting operations performed by the radiation image recording and read-out system, which comprises the radiation detecting section 100 and the AMA board 200 joined together, are described in, for example, Japanese Unexamined Patent Publication No. 11(1999)-287862.

The present invention will further be illustrated by the following non-limitative examples.

### EXAMPLES I

### Example 1

An aqueous NH₃ solution (28% by weight) was added to a mixed methoxy ethanol solution of 5N Bi(NO₃)₃.5H₂O and 6N Ti(O-i-C₃H₇)₄, and a Bi₁₂TiO₂₀ precursor was thereby obtained. The thus obtained Bi₁₂TiO₂₀ precursor was subjected to molding processing with a uniaxial press (10 MPa˜140 MPa) and thereafter subjected to CIP molding processing (200 MPa˜700 MPa). The thus molded B₁₂TiO₂₀ precursor was then subjected to firing processing in an ambient atmosphere at a temperature of 800° C. for two hours and under an Ar flow condition, and a Bi₁₂TiO₂₀ fired film was thereby formed. The Bi₁₂TiO₂₀ fired film was then adhered to an ITO base plate by use of a silver paste. Thereafter, an Au layer acting as a top electrode was formed with sputtering processing to a thickness of 60 nm on the Bi₁₂TiO₂₀ fired film, which had been adhered to the ITO base plate. In this manner, a radiation imaging panel, which was provided with a photo-conductor layer constituted of the Bi₁₂TiO₂₀ fired film, was obtained.

### Example 2

A radiation imaging panel, which was provided with a photo-conductor layer constituted of a Bi₁₂SiO₂₀ fired film, was obtained in the same manner as that in Example 1, except that, in lieu of Ti(O-i-C₃H₇)₄ utilized in Example 1, Si(O—C₂H₅)₄ was utilized.

### Example 3

A radiation imaging panel, which was provided with a photo-conductor layer constituted of a Bi₁₂GeO₂₀ fired film, was obtained in the same manner as that in Example 1, except that, in lieu of Ti (O-i-C₃H₇)₄ utilized in Example 1, Ge(O—C₂H₅)₄ was utilized.

### Example 4

A radiation imaging panel, which was provided with a photo-conductor layer constituted of a Bi₁₂TiO₂₀ fired film, was obtained in the same manner as that in Example 1, except that only the molding processing with the uniaxial press (10 MPa˜140 MPa) was performed, and the CIP molding processing was not performed.

### Comparative Example 1

Firstly, Bi₂O₃ particles and TiO₂ particles were mixed together, the resulting mixed particles were subjected to firing processing at a temperature of 800° C., and Bi₁₂TiO₂₀ particles were thereby obtained. The thus obtained Bi₁₂TiO₂₀ particles were then subjected to molding processing with a uniaxial press at 42 MPa. The thus molded particles were then subjected to sintering processing at a temperature of 800° C. for two hours and under an Ar flow condition, and a sintered film was thereby obtained. The sintered film was then adhered to an ITO base plate by use of a silver paste. Thereafter, an Au layer acting as a top electrode was formed with sputtering processing to a thickness of 60 nm on the Bi₁₂TiO₂₀ sintered film, which had been adhered to the ITO base plate. In this manner, a radiation imaging panel, which was provided with a photo-conductor layer constituted of the Bi₁₂TiO₂₀ sintered film, was obtained.

### Comparative Example 2

A radiation imaging panel, which was provided with a photo-conductor layer constituted of a Bi₁₂SiO₂₀ film, was obtained in the same manner as that in Comparative Example 1, except that, in lieu of the TiO₂ particles utilized in Comparative Example 1, SiO₂ particles were utilized.

### Comparative Example 3

A radiation imaging panel, which was provided with a photo-conductor layer constituted of a Bi₁₂GeO₂₀ film, was obtained in the same manner as that in Comparative Example 1, except that, in lieu of the TiO₂ particles utilized in Comparative Example 1, GeO₂ particles were utilized.

(Evaluation Method and Results of Evaluation)

To each of the radiation imaging panels having been obtained in Examples 1, 2, 3, and 4 and Comparative Examples 1, 2, and 3, 10 mR X-rays were irradiated for 0.1 second under the condition of a voltage of 2.5V/μm. A pulsed photo-current occurring under the condition of voltage application was converted into a voltage by use of a current amplifier, and the voltage was measured with a digital oscilloscope. In accordance with the obtained current-time curve, integration was made within the range of the X-ray irradiation time, and the quantity of the formed electric charges was measured. As a result, each of the photo-conductor layers of the radiation imaging panels, which were obtained in Examples 1, 2, and 3, exhibited a value 1.8 times as large as the value of each of the photo-conductor layers of the radiation imaging panels, which were obtained in Comparative Examples 1, 2, and 3. (The value was expressed in terms of the value obtained with a film thickness of 200 μm.) The photo-conductor layer of the radiation imaging panel obtained in Example 4, in which the CIP molding processing was not performed, exhibited a value 1.2 times as large as the value of the photo-conductor layer of the radiation imaging panel, which was obtained in Comparative Example 1.

As described above, with the first process for producing a photo-conductor layer for constituting a radiation imaging panel in accordance with the present invention, the mixed solution of the bismuth salt and the metal alkoxide is mixed together with the aqueous alkali solution, and the Bi₁₂MO₂₀ precursor is thereby obtained. Also, the thus obtained Bi₁₂MO₂₀ precursor is subjected to the molding processing, the thus molded Bi₁₂MO₂₀ precursor is subjected to the firing processing, and the photo-conductor layer is thereby produced. Therefore, the advantages over the conventional solid phase technique are capable of being obtained in that the particle diameter of the obtained particles is capable of being kept on the order of as small as a sub-micron size, and in that the packing density of Bi₁₂MO₂₀ in the photo-conductor layer is capable of being kept high. The sensitivity is thus capable of being kept higher than the sensitivity obtained with the conventional solid phase technique. Accordingly, the effect of collecting the formed electric charges is capable of being enhanced, and electric noise is capable of being suppressed. As a result, graininess characteristics of the obtained image are capable of being enhanced, and the photo-conductor layer having a high sensitivity is capable of being obtained.

### EXAMPLES II

### Example 5

An aqueous NH₃ solution (28% by weight) was added to a mixed methoxy ethanol solution of 5N Bi(NO₃)₃.5H₂O and 6N Ti(O-i-C₃H₇)₄, and a Bi₁₂TiO₂₀ precursor was thereby obtained. The thus obtained Bi₁₂TiO₂₀ precursor was subjected to hydrothermal processing in an aqueous NH₃ solution (28% by weight) at a temperature of 200° C. by use of a pressure-resistant vessel (Parr Acid Digestion Bombs, supplied by PARR Co.), and Bi₁₂TiO₂₀ particles were thereby obtained. The thus obtained Bi₁₂TiO₂₀ particles were subjected to molding processing with a uniaxial press at 42 MPa. The thus molded particles were then subjected to sintering processing at a temperature of 800° C. for two hours and under an Ar flow condition, and a sintered film was thereby obtained. The sintered film was then adhered to an ITO base plate by use of a silver paste. Thereafter, an Au layer acting as a top electrode was formed with sputtering processing to a thickness of 60 nm on the Bi₁₂TiO₂₀ sintered film, which had been adhered to the ITO base plate. In this manner, a radiation imaging panel, which was provided with a photo-conductor layer constituted of the Bi₁₂TiO₂₀ sintered film, was obtained.

### Example 6

A radiation imaging panel, which was provided with a photo-conductor layer constituted of a Bi₁₂SiO₂₀ film, was obtained in the same manner as that in Example 5, except that, in lieu of Ti(O-i-C₃H₇)₄ utilized in Example 5, Si(O—C₂H₅)₄ was utilized, and the liquid-phase heating temperature was set at 100° C.

### Example 7

A radiation imaging panel, which was provided with a photo-conductor layer constituted of a Bi₁₂GeO₂₀ film, was obtained in the same manner as that in Example 6, except that, in lieu of Ti(O-i-C₃H₇)₄ utilized in Example 5, Ge(O—C₂H₅)₄ was utilized.

### Comparative Example 4

Firstly, Bi₂O₃ particles and TiO₂ particles were mixed together, the resulting mixed particles were subjected to firing processing at a temperature of 800° C., and Bi₁₂TiO₂O particles were thereby obtained. The thus obtained Bi₁₂TiO₂₀ particles were then subjected to molding processing with a uniaxial press at 42 MPa. The thus molded particles were then subjected to sintering processing at a temperature of 800° C. for two hours and under an Ar flow condition, and a sintered film was thereby obtained. The sintered film was then adhered to an ITO base plate by use of a silver paste. Thereafter, an Au layer acting as a top electrode was formed with sputtering processing to a thickness of 60 nm on the Bi₁₂TiO₂₀ sintered film, which had been adhered to the ITO base plate. In this manner, a radiation imaging panel, which was provided with a photo-conductor layer constituted of the Bi₁₂TiO₂₀ sintered film, was obtained.

### Comparative Example 5

A radiation imaging panel, which was provided with a photo-conductor layer constituted of a Bi₁₂SiO₂₀ film, was obtained in the same manner as that in Comparative Example 4, except that, in lieu of the TiO₂ particles utilized in Comparative Example 4, SiO₂ particles were utilized.

### Comparative Example 6

A radiation imaging panel, which was provided with a photo-conductor layer constituted of a Bi₁₂GeO₂₀ film, was obtained in the same manner as that in Comparative Example 4, except that, in lieu of the TiO₂ particles utilized in Comparative Example 4, GeO₂ particles were utilized.

(Evaluation Method and Results of Evaluation)

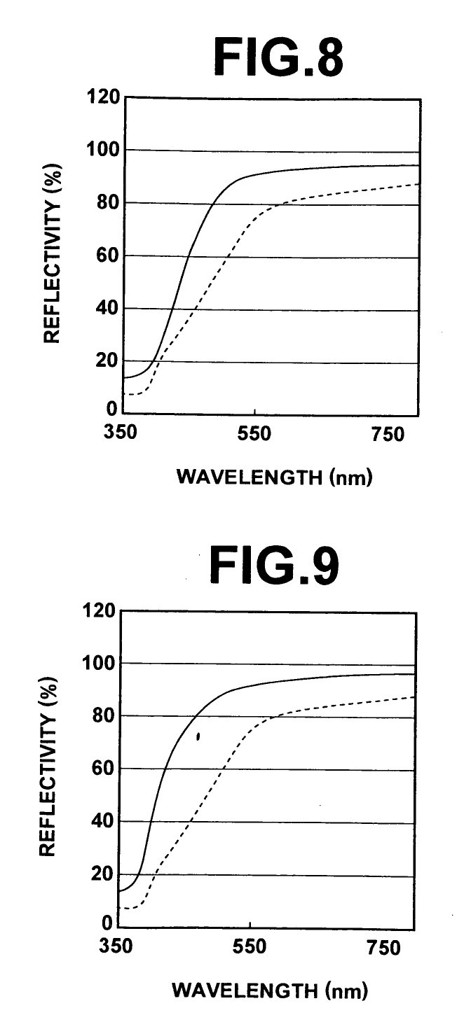

FIG. 8 is a graph showing reflection spectrums of the Bi₁₂TiO₂₀ particles obtained in Example 5 (with the liquid phase technique) and the Bi₁₂TiO₂₀ particles obtained in Comparative Example 4 (with the solid phase technique). In FIG. 8, the solid line represents the reflection spectrum of the Bi₁₂TiO₂₀ particles obtained in Example 5, and the dotted line represents the reflection spectrum of the Bi₁₂TiO₂₀ particles obtained in Comparative Example 4. As clear from FIG. 8, it is capable of being found that the Bi₁₂TiO₂₀ particles obtained in Example 5 exhibit a reflectivity higher than the reflectivity of the Bi₁₂TiO₂₀ particles obtained in Comparative Example 4. From the viewpoint of the kind of the substance, both the Bi₁₂Ti₂₀ particles obtained in Example 5 and the Bi₁₂TiO₂₀ particles obtained in Comparative Example 4 are constituted of the same substance, i.e. Bi₁₂TiO₂₀. Therefore, the difference between the reflectivity of the Bi₁₂TiO₂₀ particles obtained in Example 5 and the reflectivity of the Bi₁₂Ti₂₀ particles obtained in Comparative Example 4 is due to a difference in crystal defect. Since the reflectivity is high in cases where little crystal defect occurs, it is capable of being found that the Bi₁₂Ti₂₀ particles obtained in Example 5 has less crystal defect than the Bi₁₂TiO₂₀ particles obtained in Comparative Example 4.

To each of the radiation imaging panels having been obtained in Examples 5, 6, and 7 and Comparative Examples 4, 5, and 6, 10mR X-rays were irradiated for 0.1 second under the condition of a voltage of 2.5V/μm. A pulsed photo-current occurring under the condition of voltage application was converted into a voltage by use of a current amplifier, and the voltage was measured with a digital oscilloscope. In accordance with the obtained current-time curve, integration was made within the range of the X-ray irradiation time, and the quantity of the formed electric charges was measured. As a result, each of the photo-conductor layers of the radiation imaging panels, which were obtained in Examples 5, 6, and 7, exhibited a value 1.5 times as large as the value of each of the photo-conductor layers of the radiation imaging panels, which were obtained in Comparative Examples 4, 5, and 6. (The value was expressed in terms of the value obtained with a film thickness of 200 μm.)

As described above, with the second process for producing a photo-conductor layer for constituting a radiation imaging panel in accordance with the present invention, the mixed solution of the bismuth salt and the metal alkoxide is mixed together with the aqueous alkali solution, and the Bi₁₂MO₂₀ precursor is thereby obtained. Also, the thus obtained Bi₁₂MO₂₀ precursor is subjected to the heating processing in the alkaline liquid phase, and the Bi₁₂MO₂₀ particles are thereby obtained. Further, the photo-conductor layer is produced from the Bi₁₂MO₂₀ particles having thus been obtained. Therefore, the effect of collecting the formed electric charges is capable of being enhanced, and electric noise is capable of being suppressed. As a result, the graininess characteristics of the obtained image are capable of being enhanced, and the photo-conductor layer having a sensitivity higher than the sensitivity of the photo-conductor layer obtained with the solid phase technique is capable of being obtained.

### EXAMPLES III

### Example 8

An aqueous NH₃ solution (28% by weight) was added to a mixed methoxy ethanol solution of 5N Bi(NO₃)₃.5H₂O and 6N Ti(O-i-C₃H₇)₄, and a Bi₁₂TiO₂₀ precursor was thereby obtained. The thus obtained Bi₁₂TiO₂₀ precursor was subjected to firing processing in an ambient atmosphere at a temperature of 700° C. for two hours, and crystallized Bi₁₂TiO₂₀ particles were thereby obtained. The thus obtained Bi₁₂TiO₂₀ particles were subjected to molding processing with a uniaxial press at 42 MPa. The thus molded particles were then subjected to sintering processing at a temperature of 800° C. for two hours and under an Ar flow condition, and a sintered film was thereby obtained. The sintered film was then adhered to an ITO base plate by use of a silver paste. Thereafter, an Au layer acting as a top electrode was formed with sputtering processing to a thickness of 60 nm on the Bi₁₂TiO₂₀ sintered film, which had been adhered to the ITO base plate. In this manner, a radiation imaging panel, which was provided with a photo-conductor layer constituted of the Bi₁₂TiO₂₀ sintered film, was obtained.

### Example 9

A radiation imaging panel, which was provided with a photo-conductor layer constituted of a Bi₁₂SiO₂₀ film, was obtained in the same manner as that in Example 8, except that, in lieu of Ti(O-i-C₃H₇)₄ utilized in Example 8, Si(O—C₂H₅)₄ was utilized.

### Example 10

A radiation imaging panel, which was provided with a photo-conductor layer constituted of a Bi₁₂GeO₂₀ film, was obtained in the same manner as that in Example 8, except that, in lieu of Ti(O-i-C₃H₇)₄ utilized in Example 8, Ge(O—C₂H₅)₄ was utilized.

### Comparative Example 7

Firstly, Bi₂O₃ particles and TiO₂ particles were mixed together, the resulting mixed particles were subjected to firing processing at a temperature of 800° C., and Bi₁₂TiO₂₀ particles were thereby obtained. The thus obtained Bi₁₂TiO₂₀ particles were then subjected to molding processing with a uniaxial press at 42 MPa. The thus molded particles were then subjected to sintering processing at a temperature of 800° C. for two hours and under an Ar flow condition, and a sintered film was thereby obtained. The sintered film was then adhered to an ITO base plate by use of a silver paste. Thereafter, an Au layer acting as a top electrode was formed with sputtering processing to a thickness of 60 nm on the Bi₁₂TiO₂₀ sintered film, which had been adhered to the ITO base plate. In this manner, a radiation imaging panel, which was provided with a photo-conductor layer constituted of the Bi₁₂TiO₂₀ sintered film, was obtained.

### Comparative Example 8

A radiation imaging panel, which was provided with a photo-conductor layer constituted of a Bi₁₂SiO₂₀ film, was obtained in the same manner as that in Comparative Example 7, except that, in lieu of the TiO₂ particles utilized in Comparative Example 7, SiO₂ particles were utilized.

### Comparative Example 9

A radiation imaging panel, which was provided with a photo-conductor layer constituted of a Bi₁₂GeO₂₀ film, was obtained in the same manner as that in Comparative Example 7, except that, in lieu of the TiO₂ particles utilized in Comparative Example 7, GeO₂ particles were utilized.

(Evaluation Method and Results of Evaluation)

FIG. 9 is a graph showing reflection spectrums of the Bi₁₂TiO₂₀ particles obtained in Example 8 (with the liquid phase technique) and the Bi₁₂TiO₂₀ particles obtained in Comparative Example 7 (with the solid phase technique). In FIG. 9, the solid line represents the reflection spectrum of the Bi₁₂TiO₂₀ particles obtained in Example 8, and the dotted line represents the reflection spectrum of the Bi₁₂TiO₂₀ particles obtained in Comparative Example 7. As clear from FIG. 9, it is capable of being found that the Bi₁₂TiO₂₀ particles obtained in Example 8 exhibit a reflectivity higher than the reflectivity of the Bi₁₂TiO₂₀ particles obtained in Comparative Example 7. From the viewpoint of the kind of the substance, both the Bi₁₂TiO₂₀ particles obtained in Example 8 and the Bi₁₂TiO₂₀ particles obtained in Comparative Example 7 are constituted of the same substance, i.e. Bi₂TiO₂₀. Therefore, the difference between the reflectivity of the Bi₁₂TiO₂₀ particles obtained in Example 8 and the reflectivity of the Bi₁₂TiO₂₀ particles obtained in Comparative Example 7 is due to a difference in crystal defect. Since the reflectivity is high in cases where little crystal defect occurs, it is capable of being found that the Bi₁₂TiO₂₀ particles obtained in Example 8 has less crystal defect than the Bi₁₂TiO₂₀ particles obtained in Comparative Example 7.

To each of the radiation imaging panels having been obtained in Examples 8, 9, and 10 and Comparative Examples 7, 8, and 9, 10mR X-rays were irradiated for 0.1 second under the condition of a voltage of 2.5V/μm. A pulsed photo-current occurring under the condition of voltage application was converted into a voltage by use of a current amplifier, and the voltage was measured with a digital oscilloscope. In accordance with the obtained current-time curve, integration was made within the range of the X-ray irradiation time, and the quantity of the formed electric charges was measured. As a result, each of the photo-conductor layers of the radiation imaging panels, which were obtained in Examples 8, 9, and 10, exhibited a value 1.2 times as large as the value of each of the photo-conductor layers of the radiation imaging panels, which were obtained in Comparative Examples 7, 8, and 9. (The value was expressed in terms of the value obtained with a film thickness of 200 μm.)

As described above, with the third process for producing a photo-conductor layer for constituting a radiation imaging panel in accordance with the present invention, the mixed solution of the bismuth salt and the metal alkoxide is mixed together with the aqueous alkali solution, and the Bi₂MO₂₀ precursor is thereby obtained. Also, the thus obtained Bi₁₂MO₂₀ precursor is subjected to the firing processing, and the Bi₂MO₂₀ particles are thereby obtained. Further, the photo-conductor layer is produced from the Bi₁₂MO₂₀ particles having thus been obtained. Therefore, the effect of collecting the formed electric charges is capable of being enhanced, and electric noise is capable of being suppressed. As a result, the graininess characteristics of the obtained image are capable of being enhanced, and the photo-conductor layer having a high sensitivity is capable of being obtained.

What is claimed is:

1. A process for producing a Bi₁₂MO₂₀ precursor, comprising the steps of:
i) preparing a mixed solution of a bismuth salt and a metal alkoxide, and
ii) mixing the mixed solution of the bismuth salt and the metal alkoxide together with an aqueous alkali solution,
whereby a Bi₁₂MO₂₀ precursor, in which M represents at least one kind of element selected from the group consisting of Ge, Si, and Ti, is obtained.

2. A process for producing a Bi₁₂MO₂₀ precursor as defined in claim 1 wherein the bismuth salt is selected from the group consisting of bismuth nitrate and bismuth acetate.

3. A process for producing a photo-conductor layer for constituting a radiation imaging panel, which photo-conductor layer is capable of recording radiation image information as an electrostatic latent image, the process comprising the steps of:
i) subjecting the Bi₁₂MO₂₀ precursor, which has been obtained with a process for producing a Bi₁₂MO₂₀ precursor as defined in claim 2, to molding processing, and
ii) subjecting the thus molded Bi₁₂MO₂₀ precursor to firing processing,
whereby the photo-conductor layer is produced.

4. A process for producing a photo-conductor layer for constituting a radiation imaging panel as defined in claim 3 wherein the molding processing of the Bi₁₂MO₂₀ precursor is performed with a cold isostatic pressing technique.

5. A process for producing a photo-conductor layer for constituting a radiation imaging panel as defined in claim 4 wherein the molding processing is performed at a pressure falling within the range of 100 MPa to 700 MPa.

6. A process for producing Bi₁₂MO₂₀ particles, comprising the steps of:
i) preparing a mixed solution of a bismuth salt and a metal alkoxide,
ii) mixing the mixed solution of the bismuth salt and the metal alkoxide together with an aqueous alkali solution, a Bi₁₂MO₂₀ precursor, in which M represents at least one kind of element selected from the group consisting of Ge, Si, and Ti, being thereby obtained, and
iii) subjecting the thus obtained Bi₁₂MO₂₀ precursor to heating processing in an alkaline liquid phase,
whereby the Bi₁₂MO₂₀ particles are obtained.

7. A process for producing Bi₁₂MO₂O particles as defined in claim 6 wherein the heating processing in the alkaline liquid phase is hydrothermal processing.

8. A process for producing Bi₁₂MO₂₀ particles as defined in claim 6 wherein the heating processing in the alkaline liquid phase is performed at a temperature falling within the range of 50° C. to 250° C.

9. A process for producing Bi₁₂MO₂₀ particles as defined in claim 7 wherein the bismuth salt is selected from the group consisting of bismuth nitrate and bismuth acetate.

10. A process for producing Bi₁₂MO₂₀ particles as defined in claim 8 wherein the bismuth salt is selected from the group consisting of bismuth nitrate and bismuth acetate.

11. A process for producing a photo-conductor layer for constituting a radiation imaging panel, which photo-conductor layer is capable of recording radiation image information as an electrostatic latent image, the process comprising the step of:
producing the photo-conductor layer by use of the Bi₁₂MO₂₀ particles, which have been obtained with a process for producing Bi₁₂MO₂₀ particles as defined in claim 9.

12. A process for producing a photo-conductor layer for constituting a radiation imaging panel, which photo-conductor layer is capable of recording radiation image information as an electrostatic latent image, the process comprising the step of:
producing the photo-conductor layer by use of the Bi₁₂MO₂₀ particles, which have been obtained with a process for producing Bi₁₂MO₂₀ particles as defined in claim 10.

13. A process for producing Bi₁₂MO₂₀ particles, comprising the steps of:
i) preparing a mixed solution of a bismuth salt and a metal alkoxide,
ii) mixing the mixed solution of the bismuth salt and the metal alkoxide together with an aqueous alkali solution, a Bi₁₂MO₂₀ precursor, in which M represents at least one kind of element selected from the group consisting of Ge, Si, and Ti, being thereby obtained, and
iii) subjecting the thus obtained Bi₁₂MO₂₀ precursor to firing processing,
whereby the Bi₁₂MO₂₀ particles are obtained.

14. A process for producing Bi₁₂MO₂₀ particles as defined in claim 13 wherein the bismuth salt is selected from the group consisting of bismuth nitrate and bismuth acetate.

15. A process for producing a photo-conductor layer for constituting a radiation imaging panel, which photo-conductor layer is capable of recording radiation image information as an electrostatic latent image, the process comprising the step of:
producing the photo-conductor layer by use of the Bi₁₂MO₂₀ particles, which have been obtained with a process for producing Bi₁₂MO₂₀ particles as defined in claim 14.
